(19) United States
(12) Patent Application Publication
(10) Pub. No.: US 2026/0185690 A1
(43) Pub. Date: Jul. 2, 2026

(54) Worksite Lamp

(71) Applicant: Robert Bosch GmbH, Stuttgart (DE)

(72) Inventors: Benedikt Kollitz, Stuttgart (DE); Christian Rothweiler, Aldingen (DE); Philipp Zewe, Nuertingen (DE); Thorsten Schaal, Stuttgart (DE)

(21) Appl. No.: 19/428,210

(22) Filed: Dec. 21, 2025

(30) Foreign Application Priority Data
Dec. 27, 2024 (DE) 10 2024 212 305.6

(51) Int. Cl. F21V 29/56; F21L 4/00; F21V 31/00

(52) U.S. Cl. CPC F21V 29/56; F21L 4/00; F21V 31/005

(57) ABSTRACT

A worksite lamp, in particular, a 360° worksite lamp includes a housing, at least one battery receptacle interface arranged on the housing, and at least one lighting unit which is provided to emit light over an angular range of more than 120°, in particular, more than 180°. The worksite lamp further includes at least one fluid-conducting unit which is provided to conduct fluid, in particular, water and/or cooling air, through the housing and through the lighting unit past the battery receptacle interface.

This application claims priority under 35 U.S.C. § 119 to patent application no. DE 10 2024 212 305.6, filed on Dec. 27, 2024 in Germany, the disclosure of which is incorporated herein by reference in its entirety.

### BACKGROUND

A worksite lamp comprising a housing, in particular, a 360° worksite lamp, comprising at least one battery receptacle interface arranged on the housing, and comprising at least one lighting unit that is provided to emit light over an angular range of more than 120°, in particular, more than 180°, is already known.

### SUMMARY

The disclosure relates to a worksite lamp, in particular, a 360° worksite lamp, comprising a housing, at least one battery receptacle interface arranged on the housing, and at least one lighting unit, which is provided to emit light over an angular range of more than 120°, in particular, more than 180°.

It is proposed that the worksite lamp comprises at least one fluid-conducting unit that is provided to route fluid, in particular, water and/or cooling air, through the housing and through the lighting unit past the battery receptacle interface. According to the disclosure, the configuration of the worksite lamp allows for an advantageously efficient cooling to be provided, in particular of a light source of the lighting unit, of a power and/or control electronics unit, and/or of a battery pack arranged at the battery receptacle interface. Particularly advantageously, a stream of cooling air may be provided by convection. Furthermore, water, which has entered the housing and/or the lighting unit, for example, as a result of rain or condensation, may advantageously be guided out of the housing and/or the lighting unit past the battery receptacle interface, in particular, advantageously discharged from the housing. Advantageously, corrosion and electrical short circuits may be counteracted. Particularly advantageously, a particularly high operational reliability may be provided. Furthermore, an advantageously long service life of a worksite lamp may be achieved.

The worksite lamp is preferably provided to illuminate a work area, in particular, a worksite work area. Preferably, the worksite lamp is formed as a battery-operated worksite lamp, more preferably as a battery-pack-operated worksite lamp. However, it is also possible for the worksite lamp to be formed as a corded worksite lamp. The lighting unit of the worksite lamp preferably comprises at least one illuminant. Preferably, the illuminant is formed as an LED light. However, it is also conceivable that the illuminant has another embodiment, which appears suitable to a person skilled in the art, such as, for example, an embodiment as a halogen light or the like. More preferably, the lighting unit comprises a plurality of LEDs. Furthermore, the lighting unit preferably comprises at least one diffuser and/or protective element. The diffuser and/or protective element is preferably provided to protect the illuminant, for example, against external mechanical influences and/or weather influences. Furthermore, the diffuser and/or protective element is preferably provided to provide uniform emission of light. The diffuser and/or protective element is preferably formed as a diffuser. Preferably, the diffuser and/or protective element is manufactured from a plastic, preferably, from a transparent and, more preferably, from a translucent plastic, for example, polycarbonate or the like. It is conceivable for the diffuser and/or protective element to comprise lenses, prisms, or other optical elements for uniform light distribution. Preferably, the lighting unit of the worksite lamp emits light over an angular range of at least 130°, preferably at least 180°, more preferably at least 270°, and most preferably 360°. Preferably, a light intensity of the lighting unit, in particular, of the illuminant, is adjustable. Preferably, the lighting unit is provided to emit, preferably, white light, more preferably, daylight-white light. Alternatively, it is conceivable that the lighting unit emits yellow, orange, or other-colored light.

Preferably, the housing of the worksite lamp is manufactured at least in part, in particular, completely, from a plastic. Alternatively or additionally, the housing of the worksite lamp is manufactured at least in part, in particular, completely, from a metal. Alternatively, however, it is also conceivable that the housing is manufactured from a combination of materials of any kind. The housing preferably comprises a lighting-unit interface at which the lighting unit is arrangeable. Preferably, the housing comprises a support element formed, in particular, as a rubber foot, in particular, four rubber feet, which is/are preferably provided to position the worksite lamp in a slip-resistant manner on an underlying surface and/or to counteract transmission of vibrations to the worksite lamp. The worksite lamp preferably comprises an operating unit comprising at least one operating element. Preferably, the operating element is formed as a pushbutton switch, rocker switch, toggle switch, capacitive touch switch, or the like. Preferably, the operating element is arranged on the housing. Furthermore, the worksite lamp preferably comprises a power-supply interface arranged on the housing. The power-supply interface is preferably formed as a USB interface, AC interface, DC interface, or the like. In particular, the power-supply interface is provided to charge a battery pack arranged in a state at the battery receptacle interface and/or to supply the worksite lamp, in particular, the lighting unit, with electrical energy.

The fluid-conducting unit is preferably provided to discharge heat from the illuminant of the lighting unit and/or from the battery pack in an installed state at the battery receptacle interface. Preferably, the fluid-conducting unit, in particular, alternatively or additionally, is provided to counteract ingress of water into electrical and/or electronic components of the worksite lamp. The fluid-conducting unit preferably comprises at least one fully, in particular, fluid-tight, closed channel. However, it is also conceivable that the fluid-conducting unit comprises a plurality of channels through which the fluid can flow. Preferably, the fluid-conducting unit extends completely through the housing and through the lighting unit. Preferably, the cooling air flows along the fluid-conducting unit due to convection. It is, however, also conceivable that the fluid-conducting unit comprises a fan, which may be provided to actively direct the cooling air along the fluid-conducting unit. Preferably, the cooling air flows past the battery receptacle interface from the housing into the lighting unit. Alternatively, it is conceivable that the cooling air flows from the lighting unit into the housing past the battery receptacle interface. Preferably, the fluid-conducting unit comprises at least one heat exchanger, in particular, a heat sink formed preferably from aluminum, along which the cooling air is routed for discharging heat that arises, for example, at the illuminant, the battery pack, or a power and/or control electronics unit. “Provided” is understood, in particular, as meaning specifically adapted, specifically designed, and/or specifically equipped. In particular, “provided for a specific function” is provided to be understood to mean that the object fulfills and/or performs this specific function in at least one in-use state and/or operating state.

It is further proposed that the fluid-conducting unit comprises at least one fluid inlet and/or fluid outlet element that is arranged in a near region of the battery receptacle interface. Preferably, the fluid inlet and/or fluid outlet element has a smallest distance of preferably less than 100 mm, preferably less than 50 mm, and more preferably less than 20 mm relative to the battery receptacle interface. The at least one fluid inlet and/or fluid outlet element is preferably provided to allow the cooling air to flow into the housing or to flow out of the housing. More preferably, the at least one fluid inlet and/or fluid outlet element is provided to route cooling air past the battery receptacle interface. Furthermore, the at least one fluid inlet and/or fluid outlet element may be provided to allow water to preferably flow out of the housing, alternatively or additionally to the cooling air. The at least one fluid inlet and/or fluid outlet element preferably delimits one, more preferably a plurality of, fluid inlet and/or fluid outlet opening(s). Preferably, the fluid inlet and/or fluid outlet opening(s) are slot-like and arranged in an outer wall of the housing. However, it is also conceivable that the fluid inlet and/or fluid outlet opening(s) has/have a circular shape, polygonal shape, or the like. Alternatively, it is also conceivable that the at least one fluid inlet and/or fluid outlet element is formed as a hose, in particular, a flexible hose, which is manufactured, for example, from silicone, plastic, or the like. The term “near region” is to be understood, in particular, as a spherical space around a point, wherein the radius of the spherical space is preferably less than 100 mm, preferably less than 50 mm, and more preferably less than 20 mm. By way of such a configuration, an advantageously efficient cooling of the battery pack arranged at the battery receptacle interface may be provided. Furthermore, an available installation space in the housing may be used efficiently. Furthermore, water, which has entered the housing and/or the lighting unit, for example, as a result of rain or condensation, may advantageously be guided out of the housing and/or the lighting unit past the battery receptacle interface, in particular, advantageously discharged from the housing. Particularly advantageously, a particularly high operational reliability may be provided.

Furthermore, it is proposed that the fluid-conducting unit comprises at least one further fluid inlet and/or fluid outlet element that is arranged on a side of the housing facing away from the lighting unit. The at least one further fluid inlet and/or fluid outlet element is preferably provided to allow water to drain out of the housing and/or to allow cooling air to flow out of or into the housing. More preferably, the at least one further fluid inlet and/or fluid outlet element is provided to allow water to drain from the housing in such a manner that contact between the draining water and other components may be counteracted. Advantageously, a particularly high level of safety may be provided. Furthermore, corrosion and electrical short circuits may advantageously be counteracted. Water, which has entered the housing and/or the lighting unit, for example, as a result of rain or condensation, may advantageously be guided out of the housing and/or the lighting unit past the battery receptacle interface, in particular, advantageously discharged from the housing. Particularly advantageously, a particularly high operational reliability may be provided. Furthermore, an advantageously long service life of a worksite lamp may be achieved.

Moreover, it is proposed that the fluid-conducting unit comprises at least one upper fluid inlet and/or fluid outlet element that is arranged on a side of the lighting unit facing away from the housing. The at least one upper fluid inlet and/or fluid outlet element is preferably provided to allow the cooling air to flow out of the lighting unit or to flow into the lighting unit. Furthermore, the at least one upper fluid inlet and/or fluid outlet element may be provided, alternatively or additionally to the cooling air, to allow water to drain out of the lighting unit, in particular, depending on an orientation of the worksite lamp relative to an underlying surface. The at least one upper fluid inlet and/or fluid outlet element preferably comprises a side wall, wherein the side wall bounds a channel that preferably has a rectangular, preferably square, cross-sectional shape in a plane lying perpendicular to a central axis of the worksite lamp. However, another polygonal or circular cross-sectional shape is also conceivable. Furthermore, the at least one upper fluid inlet and/or fluid outlet element preferably comprises a cover element on a side facing away from the lighting unit. The side wall delimits at least one, preferably a plurality of, upper fluid inlet and/or fluid outlet openings through which inflow or outflow of the fluid is enabled. Advantageously efficient cooling of the lighting unit may be provided. Furthermore, in a state in which the worksite lamp is placed on the rubber feet, ingress of water, in particular, rainwater, may advantageously be counteracted, or an advantageous discharge of water from the housing may be enabled. An advantageously high operational reliability may be achieved.

Furthermore, it is proposed that the worksite lamp comprises at least one sealing unit which is arranged at least between the fluid-conducting unit and the housing and/or between the fluid-conducting unit and the lighting unit, in particular, to counteract an ingress of water. Preferably, ingress of water into a space between the diffuser and/or protective element and the illuminant is counteracted. The sealing unit preferably comprises at least one seal, preferably, a plurality of seals. Preferably, the at least one seal is formed as an O-ring, as a flat seal, or the like, which is/are preferably arranged between the fluid-conducting unit and the housing and/or the lighting unit, in particular, in corresponding grooves or on sealing surfaces. More preferably, the at least one seal has a sealing profile that is adapted to the geometry of the housing and the fluid-conducting unit and/or the lighting unit and the fluid-conducting unit. Preferably, the seal is manufactured from an elastomer, silicone, polyurethane, or the like. Alternatively, it is also conceivable that the at least one seal is applied from a continuous seam made of a sealing material, such as, for example, silicone, polyurethane, or the like, during assembly of the worksite lamp. Preferably, the sealing unit comprises a plurality of seals of identical configuration. Alternatively, it is also conceivable that the sealing unit comprises a plurality of seals of different configuration. By way of such a configuration, escape of water from the fluid-conducting unit into the housing and/or the lighting unit may advantageously be counteracted. A particularly high operational reliability may be achieved.

It is further proposed that the worksite lamp comprises at least one power and/or control electronics unit that is provided to at least control or regulate the lighting unit, wherein the fluid-conducting unit is provided to route the fluid, in particular, the water and/or the cooling air, past the power and/or control electronics unit. The power and/or control electronics unit is preferably provided to control or regulate a power supply of the lighting unit. Preferably, the power and/or control electronics unit is furthermore provided to monitor and/or control or regulate a state of charge and/or a charging operation of the battery pack arranged at the battery receptacle interface. Preferably, the power and/or control electronics unit is furthermore provided to control or regulate different operating modes of the lighting unit. Preferably, the power and/or control electronics unit is arranged, in particular, at least in part, preferably completely, in a near region of the lighting unit, preferably on a side of the lighting unit opposite to the battery receptacle interface. Preferably, the power and/or control electronics unit is arranged, in particular, at least in part, preferably completely, on a side of a further fluid inlet and/or fluid outlet element facing away from the lighting unit. However, it is also conceivable that the power and/or control electronics unit is arranged, in particular, at least in part, preferably completely, for example, in the housing in a near region of the battery receptacle interface or the like. Preferably, the fluid-conducting unit is provided to route the cooling air past the power and/or control electronics unit for discharging heat. Furthermore, the fluid-conducting unit is preferably provided to allow water to drain from the housing, wherein contact of the power and/or control electronics unit with water may be counteracted. Advantageously, by way of such a configuration, efficient cooling may be provided. Furthermore, advantageously high operational reliability may be provided. Furthermore, a particularly long service life of the worksite lamp may be achieved.

Furthermore, it is proposed that the battery receptacle interface, considered along a battery insertion direction of the battery receptacle interface, has a minimum distance relative to an outer housing surface of the housing which is greater than 10 mm, preferably greater than 20 mm, and more preferably greater than 30 mm, wherein at least one fluid inlet and/or fluid outlet element is arranged behind the battery receptacle interface along the insertion direction. By way of such an arrangement of the battery receptacle interface, a battery pack arranged at the battery receptacle interface may be arranged completely within the housing. Preferably, a battery insertion direction extends at least substantially perpendicular to the central axis toward the central axis. The at least one fluid inlet and/or fluid outlet element arranged behind the battery receptacle interface along the insertion direction is preferably provided to route the cooling air along the battery pack arranged at the battery receptacle interface. By way of such a configuration, advantageously efficient cooling of the battery pack may be provided. Furthermore, particularly high protection of the battery pack against weather and mechanical influences may be provided advantageously. An advantageously high operational reliability may be achieved.

It is further proposed that the fluid-conducting unit comprises at least one fluid inlet and/or fluid outlet element, in particular, the fluid inlet and/or fluid outlet element already mentioned above, and at least one further fluid inlet and/or fluid outlet element, in particular, the further fluid inlet and/or fluid outlet element already mentioned above, which are arranged, in particular, respectively, on an outer housing surface of the housing and at least partially delimit a receiving space in which a battery pack, in particular, the battery pack already mentioned above, is arranged in a state in which it is arranged at the battery receptacle interface. Such an arrangement of the at least one fluid inlet and/or fluid outlet element and the at least one further fluid inlet and/or fluid outlet element is preferably provided to guide cooling air past the battery pack arranged at the battery receptacle interface, preferably, along more than one side thereof. Advantageously, an efficient cooling may be provided.

Furthermore, it is proposed that the fluid-conducting unit comprises at least one fluid inlet and/or fluid outlet element, in particular, the fluid inlet and/or fluid outlet element already mentioned above, and at least one further fluid inlet and/or fluid outlet element, in particular, the further fluid inlet and/or fluid outlet element already mentioned above, which are arranged on the housing and delimit an inlet and/or outlet opening in different planes. An arrangement of the at least one fluid inlet and/or fluid outlet element and the at least one further fluid inlet and/or fluid outlet element is preferably provided such that, for example, cooling air may flow into the fluid line unit through an inlet and/or outlet opening in one plane, for example, a plane arranged within the housing, and may flow out through an inlet and/or outlet opening, in particular, through a further inlet and/or outlet opening, which is arranged in another plane, for example, a plane arranged within the lighting unit. The planes are preferably arranged perpendicular to the central axis. An inlet and/or outlet opening arranged in a lowest plane is preferably provided to allow water to drain. By way of such a configuration, cooling air may flow advantageously efficiently through the worksite lamp.

Furthermore, it is proposed that the lighting unit comprises at least one heat sink, in particular, the heat sink already mentioned above, which delimits a channel of the fluid-conducting unit, in particular, a channel which is completely closed circumferentially, said channel being fluidically connected to a further channel of the fluid-conducting unit which is arranged on the housing and opens into a near region of the battery receptacle interface. The heat sink is preferably provided to discharge heat from the lighting unit. Preferably, the heat sink has a substantially hollow-cylindrical basic shape. Preferably, the heat sink comprises at least one cooling fin, preferably a plurality of cooling fins, which is/are arranged on an inner side of the heat sink and extend(s) radially into the channel. Preferably, the illuminant is arranged on an outer surface of the heat sink. Preferably, the channel of the heat sink, in particular, the circumferentially completely closed channel, extends at least substantially parallel to the central axis. Preferably, the heat sink is manufactured from aluminum. However, an embodiment made of another material which appears suitable to a person skilled in the art is also conceivable. Preferably, a seal of the sealing unit is arranged between the channel and the further channel of the fluid-conducting unit and is provided to counteract leakage of fluid from the fluid-conducting unit into the housing and/or the lighting unit. An advantageously simple construction may be provided. Furthermore, a construction having advantageously few components may be provided. An efficient cooling of the lighting unit may be provided.

The worksite lamp according to the disclosure is not intended to be limited to the application and embodiment described above. In particular, the worksite lamp according to the disclosure may have a number of individual elements, components, units, and method steps that differs from the number specified herein in order to achieve a functionality described herein. Moreover, for the value ranges specified in this disclosure, values lying within the mentioned limits are also provided to be regarded as disclosed and as arbitrarily usable.

### BRIEF DESCRIPTION OF THE DRAWINGS

Further advantages follow from the description of the drawings below. An exemplary embodiment of the disclosure is shown in the drawing. The drawings, the description, and the claims contain numerous features in combination. A person skilled in the art will also appropriately consider the features individually and combine them into further meaningful combinations.

It shows:

FIG. 1 a worksite lamp according to the disclosure,

FIG. 2 the worksite lamp according to the disclosure in a schematic sectional illustration in a sectional plane parallel to a central axis of the worksite lamp according to the disclosure, and

FIG. 3 a schematic flow diagram of a method according to the disclosure for operating the worksite lamp according to the disclosure.

### DETAILED DESCRIPTION

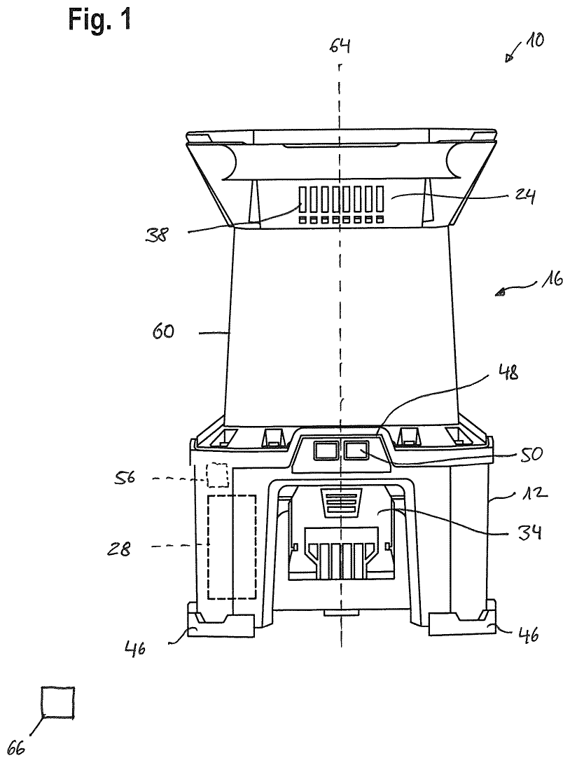

FIG. 1 shows a worksite lamp 10 comprising a housing 12. The worksite lamp 10 is formed as a battery-operated worksite lamp 10. The worksite lamp 10 comprises a battery receptacle interface 14 for receiving a battery pack 34 for supplying energy to a lighting unit 16 of the worksite lamp 10. The battery receptacle interface 14 is arranged on the housing 12, in particular, on a side of the housing 12 facing away from the lighting unit 16. The battery receptacle interface 14 has, considered along a battery insertion direction 30 of the battery receptacle interface 14, a minimal distance relative to an outer housing surface of the housing 12, which distance is greater than 30 mm. The battery insertion direction 30 extends substantially perpendicular to a central axis 64 of the housing 12 toward the central axis 64. Alternatively, it is possible that the worksite lamp 10 is formed as a corded worksite lamp 10.

The worksite lamp 10 comprises the lighting unit 16. The lighting unit 16 comprises a plurality of illuminants formed as LED illuminants. However, it is also conceivable that the illuminants have another configuration which appears suitable to a person skilled in the art, such as, for example, a configuration as halogen illuminants or the like. The lighting unit 16 comprises at least one heat sink 40 which delimits a channel 42 of a fluid-conducting unit 18, in particular, a channel which is circumferentially completely closed, said channel being fluidically connected to a further channel 44 of the fluid-conducting unit 18 which is arranged on the housing 12 and opens into a near region of the battery receptacle interface 14. The heat sink 40 is provided to discharge heat from the lighting unit 16. The heat sink 40 has a substantially hollow-cylindrical basic shape. The heat sink 40 comprises at least one cooling fin, preferably a plurality of cooling fins, which is/are arranged on an inner side of the heat sink 40 and extend(s) radially into the channel 42. The illuminants are arranged on an outer surface of the heat sink 40. The channel 42 of the heat sink 40, in particular, the circumferentially completely closed channel, extends at least substantially parallel to the central axis 64. The heat sink 40 is manufactured from aluminum. An embodiment of the heat sink 40 made of another material which appears suitable to a person skilled in the art is also conceivable.

The lighting unit 16 furthermore comprises a diffuser and/or protective element 60 for protecting the illuminants, for example, against external mechanical influences and/or weather influences. Furthermore, the diffuser and/or protective element 60 serves to emit light uniformly from the lighting unit 16 into an environment. The diffuser and/or protective element 60 is manufactured from a translucent plastic, preferably from a transparent plastic, and more preferably from a plastic, for example, polycarbonate. It is also conceivable that the diffuser and/or protective element 60 is manufactured from a transparent plastic. Furthermore, it is conceivable that the diffuser and/or protective element 60 comprises lenses, prisms, or other optical elements for uniform light distribution. The lighting unit 16 emits light over an angular range of 360°. Alternatively, it is conceivable that the lighting unit 16 emits light over an angular range of at least 180°.

The housing 12 of the worksite lamp 10 is manufactured at least in part, in particular, completely, from a plastic. It is also conceivable that the housing 12 of the worksite lamp 10 is manufactured at least in part, in particular, completely, from a metal. The housing 12 comprises four support elements 46, which are, in particular, formed as rubber feet. It is also conceivable that the support elements 46 are formed from a material different from rubber. The support elements 46, which are, in particular, formed as rubber feet, are provided to support slip-resistant placement of the worksite lamp 10 on an underlying surface and/or to counteract transmission of vibrations to the worksite lamp 10. The worksite lamp 10 comprises an operating unit 48 comprising an operating element 50 that is arranged on the housing 12. The operating element 50 is formed as a pushbutton switch. Alternatively, it is conceivable that the operating element 50 is formed as a rocker switch, toggle switch, capacitive touch switch, or the like.

Furthermore, the worksite lamp 10 comprises a power-supply interface 58. The power-supply interface 58 is formed as a USB interface. It is also conceivable that the power-supply interface 58 is formed as an AC interface, DC interface, or the like. The power-supply interface 58 is provided to charge a battery pack 34 arranged in a state in which it is arranged at the battery receptacle interface 14 and/or to supply the worksite lamp 10, in particular, the lighting unit 16, with electrical energy.

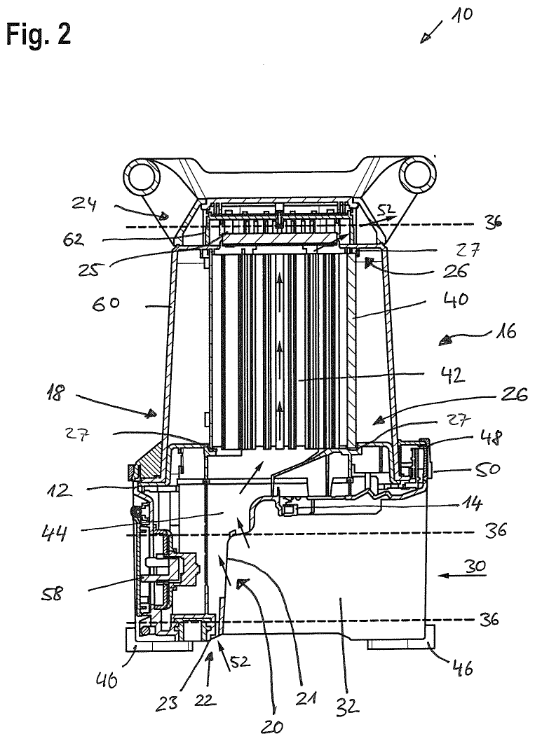

The worksite lamp 10 has the fluid-conducting unit 18, which is intended to guide fluid, in particular, water and/or cooling air 52, through the housing 12 and through the lighting unit 16 past the battery receptacle interface 14. The fluid-conducting unit 18 is provided to dissipate heat from the illuminants of the lighting unit 16 and/or from the battery pack 34 arranged in a state in which it is arranged at the battery receptacle interface 14. Furthermore, the fluid-conducting unit 18 is provided to counteract ingress of water into electrical and/or electronic components, such as, for example, printed circuit boards, contacts for switches, or the like, of the worksite lamp 10. The fluid-conducting unit 18 comprises at least one fully, in particular, fluid-tight, closed channel 42. The fluid-conducting unit 18 extends completely through the housing 12 and through the lighting unit 16. Cooling air 52 flows along the fluid-conducting unit 18, as indicated by arrows in FIG. 2, due to convection for discharging heat that arises, for example, at the illuminants of the lighting unit 16, the battery pack 34, or the like. Cooling air 52 flows into the housing 12 past the battery receptacle interface 14 from the housing 12 into the lighting unit 16. Alternatively, it is conceivable that the cooling air 52 flows from the lighting unit 16 into the housing 12 past the battery receptacle interface 14 and out of the housing 12.

The fluid-conducting unit 18 comprises at least the fluid inlet and/or fluid outlet element 20 that is arranged in a near region of the battery receptacle interface 14 with a smallest distance of less than 20 mm relative to the battery receptacle interface 14. The fluid inlet and/or fluid outlet element 20 is provided to allow cooling air 52 to flow into the housing 12 or to flow out of the housing 12. The fluid inlet and/or fluid outlet element 20 is furthermore provided to route cooling air 52 past the battery receptacle interface 14. The fluid inlet and/or fluid outlet element 20 delimits a plurality of fluid inlet and/or fluid outlet openings 21. The fluid inlet and/or fluid outlet openings 21 are slot-like and arranged in an outer housing wall of the housing 12.

The fluid-conducting unit 18 comprises at least one further fluid inlet and/or fluid outlet element 22 that is arranged on a side of the housing 12 facing away from the lighting unit 16. The further fluid inlet and/or fluid outlet element 22 delimits at least one further fluid inlet and/or fluid outlet opening 23. The further fluid inlet and/or fluid outlet opening 23 is circular and arranged in an outer housing wall of the housing 12. The further fluid inlet and/or fluid outlet element 22 is provided to allow water to drain from the housing 12 in such a manner that contact of the draining water with other components may be counteracted.

The fluid-conducting unit 18 furthermore comprises an upper fluid inlet and/or fluid outlet element 24 that is arranged on a side of the lighting unit 16 facing away from the housing 12. The upper fluid inlet and/or fluid outlet element 24 is provided to allow the cooling air 52 to flow out of the lighting unit 16. The upper fluid inlet and/or fluid outlet element 24 comprises a side wall 62, wherein the side wall 62 delimits the channel 42, which has a square cross-sectional shape in a plane 36 lying perpendicular to the central axis 64 of the worksite lamp 10. On a side facing away from the lighting unit 16, the upper fluid inlet and/or fluid outlet element 24 has a cover element. The cover element has a handle which is provided such that a user may carry the worksite lamp 10. The side wall 62 delimits a plurality of upper fluid inlet and/or fluid outlet openings 25 through which inflow or outflow of the fluid may be enabled.

The fluid-conducting unit 18 has at least the fluid inlet and/or fluid outlet element 20 and the further fluid inlet and/or fluid outlet element 22, which are arranged, in particular, respectively, on an outer housing surface of the housing 12 and at least partially delimit a receiving space 32 in which the battery pack 34 is arranged in a state in which it is arranged at the battery receptacle interface 14. Such an arrangement of the at least one fluid inlet and/or fluid outlet element 20 and the at least one further fluid inlet and/or fluid outlet element 22 is provided to guide the cooling air 52 past the battery pack 34 arranged at the battery receptacle interface 14 along more than one side. The fluid-conducting unit 18 comprises at least the fluid inlet and/or fluid outlet element 20 and the further fluid inlet and/or fluid outlet element 22, which are arranged on the housing 12 and delimit an inlet and/or outlet opening 38 in different planes 36. The planes 36 extend perpendicular to the central axis 64. Alternatively, it is possible that, by way of example, cooling air 52 flows into the fluid-conducting unit 18 through an inlet and/or outlet opening 38 in one plane 36, such as a plane 36 arranged within the housing 12, and flows out through an inlet and/or outlet opening 38, in particular, through a further opening, which may be located in another plane 36, such as, by way of example, a plane 36 arranged within the lighting unit 16.

The worksite lamp 10 comprises at least one sealing unit 26, which is arranged at least between the fluid-conducting unit 18 and the housing 12 and/or between the fluid-conducting unit 18 and the lighting unit 16, in particular, to counteract ingress of water. The sealing unit 26 acts to counteract ingress of water into a space between the diffuser and/or protective element 60 and the illuminants. The sealing unit 26 comprises a plurality of seals 27 having a sealing profile which is adapted to the geometry of the housing 12 and the fluid-conducting unit 18 and/or the lighting unit 16 and the fluid-conducting unit 18. The seals 27 are manufactured from an elastomer. An embodiment of the seals 27 made of another material which appears suitable to a person skilled in the art is also conceivable. It is also conceivable that the sealing unit 26 comprises a plurality of seals formed as O-rings.

The worksite lamp 10 further has a control or regulating unit 28 formed as a power and/or control electronics unit, which is provided to control or regulate at least the lighting unit 16, wherein the fluid-conducting unit 18 is provided to guide the fluid, in particular, the water and/or the cooling air 52, past the control or regulating unit 28 formed as a power and/or control electronics unit. The control or regulating unit 28 is arranged at least partially on a side of the lighting unit 16 opposite to a further, in particular the aforementioned, fluid inlet and/or fluid outlet element 22, and at least partially within the housing 12. The control or regulating unit 28 is provided to control or regulate a power supply of the lighting unit 16. The control or regulating unit 28 is furthermore provided to monitor and/or control or regulate a state of charge and/or a charging operation of the battery pack 34 arranged at the battery receptacle interface 14. The control or regulating unit 28 is furthermore provided to control or regulate different operating modes of the lighting unit 16.

The control or regulating unit 28 is provided to control or regulate an afterglow function with an afterglow duration, depending on an actuation of the operating element 50 provided for switching off the lighting unit 16. The control or regulating unit 28 comprises control electronics, not illustrated in further detail here, comprising a processor unit and a memory unit, and comprising an operating program stored in the memory unit. The control or regulating unit 28 is provided to set the afterglow duration, in particular, a value of the afterglow duration, of the afterglow function depending on an actuation duration, on a multiple actuation, and/or on an actuation sequence of the operating element 50. The afterglow duration, in particular, a value of the afterglow duration, is settable depending on an actuation duration of the operating element 50, wherein, for example, an actuation duration of one second corresponds to an afterglow duration of one minute or the like. Alternatively, it is conceivable that more than three stages with different values for the afterglow duration are stored in a memory unit of the control or regulating unit 28. The stages with different values for the afterglow duration are retrievable stepwise depending on the actuation duration of the operating element 50. Alternatively, it is possible that a stage of an afterglow duration is selectable by way of an actuation sequence and/or by way of a number of actuation operations of the operating element 50. Furthermore, it is conceivable that, by way of an actuation sequence of the operating element 50, a value for an afterglow duration in minutes is settable.

The worksite lamp 10 further comprises an optical, acoustic, and/or haptic output unit 54, wherein the control or regulating unit 28 is provided to output, by way of the output unit 54, a status information of the afterglow function, depending on an activation of the afterglow function, which is, in particular, formed differently from a mere afterglow of the lighting unit 16. The status information is an information about an on or off state of the afterglow function, a maximum or minimum running time of the afterglow duration, a remaining afterglow duration, or the like. The output unit 54 is provided to inform a user about a status of the worksite lamp 10 by way of an optical, acoustic, and/or haptic output. The status information is indicated by way of the lighting unit 16 of the worksite lamp 10, for example, by way of flashing, a flashing sequence, a color change of the lighting unit 16, or the like. Alternatively, it is also conceivable that the output unit 54 comprises at least one further optical, acoustic, and/or haptic output element, which is, in particular, formed differently from the lighting unit 16, such as, for example, a status LED, a loudspeaker, a buzzer, a vibration exciter, a piezo element, or the like, by way of which a status information of the afterglow function is outputtable, for example, by way of different colors, flashing, tones, vibration frequencies, amplitudes, or the like. Furthermore, it is also conceivable that the output unit 54 comprises an output element formed as a display, on which at least one status message, a selected/set maximum operating time, and/or a remaining afterglow duration is displayable. It is also conceivable that the output element is formed as a piezo buzzer, as a loudspeaker, as a voice module, or the like. A status information is outputtable by way of a voice message. Alternatively, a status information is outputtable by way of a tone or a sequence of tones. Furthermore, it is conceivable that the output element is formed as a vibration actuator, as a piezoelectric actuator, as a force feedback element, or the like, which is intended to output a tactile signal perceptible to a user. Such an actuator or such a force feedback element is preferably arranged at the operating element 50, in or on the housing 12.

The worksite lamp 10 further comprises a communication interface 56, which is provided to receive a signal, in particular, an electrical or electronic signal, from an external control device 66, in particular, from a mobile terminal, for activation and/or parameterization of the afterglow function, wherein the control or regulating unit 28 is arranged to take the received signal into account when controlling or regulating the afterglow function. The communication interface 56 is formed as a wireless communication interface 56 for transmitting and/or receiving radio signals, radio frequency signals, infrared signals, and/or Bluetooth signals. It is furthermore conceivable that the communication interface 56 is intended for a data exchange with at least one further, in particular, identically formed, worksite lamp 10.

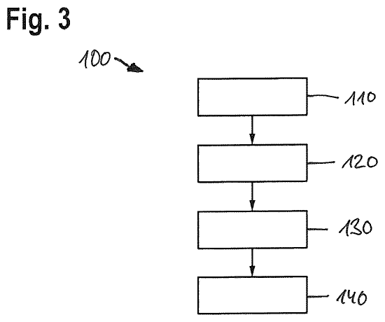

FIG. 3 shows a schematic flow program of a method 100 for operating the worksite lamp 10. In at least one method step 110, the afterglow function of the worksite lamp 10 is controlled or regulated by way of the control or regulating unit 28 of the worksite lamp 10, depending on an actuation of the operating element 50 of the worksite lamp 10, which causes switching off of the lighting unit 16. In the method step 110, upon actuation of the operating element 50, a switch-on state of the lighting unit 16 is ascertained. If the lighting unit 16 is switched on, the afterglow function is activated with an afterglow duration, in particular, with a preset value of, for example, 10 s or the like.

The lighting unit 16 is automatically switched off by way of the control or regulating unit 28 after expiry of the afterglow duration, in particular, without a further interaction by a user. In at least one method step 120 of the method 100, the afterglow duration, in particular, a value of the afterglow duration, of the afterglow function is set by an actuation duration, by a multiple actuation, and/or by an actuation sequence of the operating element 50. The afterglow duration, in particular, a value of the afterglow duration, is set as a function of the actuation duration of the operating element 50, wherein an actuation duration of one second corresponds to an afterglow duration of one minute or the like. It is also conceivable that three stages with different values for the afterglow duration are stored in the memory unit of the control or regulating unit 34, which may be retrieved stepwise depending on the actuation duration of the operating element 50. Alternatively, it is conceivable that one stage of an afterglow duration is selected by way of an actuation sequence and/or by way of a number of actuations of the operating element 50. Furthermore, it is conceivable that a value for an afterglow duration in minutes is set by way of an actuation sequence of the operating element 50.

In at least one method step 130 of the method 100, a status information of the afterglow function, which is formed, in particular, differently from a pure afterglow of the lighting unit 16, is output by way of the optical, acoustic, and/or haptic output unit 54 of the worksite lamp 10 as a function of an activation of the afterglow function. It is also conceivable that the lighting unit 16 is part of the output unit 54 and that a status is indicated by way of the lighting unit 16 of the worksite lamp 10, for example, by way of flashing, a flashing sequence, a color change of the lighting unit 16, or the like. It is furthermore possible that the output unit 54 informs a user about a status of the worksite lamp 10 by way of an acoustic and/or haptic output. Alternatively, a status information of the afterglow function is output by way of the further optical, acoustic, and/or haptic output element, such as, for example, a status LED, a loudspeaker, a buzzer, a vibration exciter, a piezo, or the like, for example, by way of different colors, flashing, tones, vibration frequencies, amplitudes, or the like. It is also possible that the output unit 54 comprises an output element formed as a display, on which at least one status message, a selected or set maximum run time, and/or a remaining afterglow duration is displayed. Furthermore, it is conceivable that a tactile signal perceptible to a user is output by way of an output element, in particular, the previously mentioned output element, which is formed as a vibration actuator, as a piezoelectric actuator, as a force feedback element, or the like.

In at least one method step 140 of the method 100, a signal, in particular, an electrical or electronic signal, received by the communication interface 56 from the external control device 66, in particular, from a mobile terminal, for activation and/or parameterization of the afterglow function is taken into account by way of the control or regulating unit 28 in controlling or regulating the afterglow function. The communication interface 56 exchanges data between the external control device 66 and the control or regulating unit 28 of the worksite lamp 10. It is conceivable that the afterglow function is controlled or regulated by way of an app installed on the mobile terminal. Furthermore, it is conceivable that the communication interface 56 exchanges data with at least one further, in particular, identically formed, worksite lamp 10, in particular, for controlling or regulating the further worksite lamp 10. The method 100 may comprise further method steps that appear suitable to a person skilled in the art. In addition, possible method steps that can be derived from the description of FIGS. 1 and 2 shall also be regarded as disclosed for the method 100.

What is claimed is:

1. A worksite lamp, comprising:
a housing;
at least one battery receptacle interface arranged on the housing;
at least one lighting unit configured to emit light over an angular range of more than 120°; and
at least one fluid-conducting unit configured to conduct fluid through the housing and through the lighting unit past the battery receptacle interface.

2. The worksite lamp according to claim 1, wherein the fluid-conducting unit comprises at least one fluid inlet and/or fluid outlet element which is arranged in a near region of the battery receptacle interface.

3. The worksite lamp according to claim 1, wherein the fluid-conducting unit comprises at least one further fluid inlet and/or fluid outlet element arranged on a side of the housing facing away from the lighting unit.

4. The worksite lamp according to claim 1, wherein the fluid-conducting unit comprises at least one fluid inlet and/or fluid outlet element arranged on a side of the lighting unit facing away from the housing.

5. The worksite lamp according to claim 1, further comprising:
at least one sealing unit arranged at least between the fluid-conducting unit and the housing and/or between the fluid-conducting unit and the lighting unit so as to counteract ingress of water.

6. The worksite lamp according to claim 1, further comprising at least one power and/or control electronics unit configured to control or regulate the at least the lighting unit,
wherein the fluid-conducting unit is configured to conduct the fluid past the power and/or control electronics unit.

7. The worksite lamp according to claim 2, wherein:
the battery receptacle interface, viewed along a battery insertion direction of the battery receptacle interface, has a minimum distance relative to an outer housing surface of the housing that is greater than 10 mm, and
the at least one fluid inlet and/or fluid outlet element is arranged behind the battery receptacle interface along the insertion direction.

8. The worksite lamp according to claim 1, wherein the fluid-conducting unit comprises at least one fluid inlet and/or fluid outlet element and at least one further fluid inlet and/or fluid outlet element, which are arranged in each case, on an outer housing surface of the housing and at least partially delimit a receiving space in which a battery pack is arranged in a state arranged at the battery receptacle interface.

9. The worksite lamp according to claim 1, wherein the fluid-conducting unit comprises at least one fluid inlet and/or fluid outlet element and at least one further fluid inlet and/or fluid outlet element, which are arranged on the housing and delimit an inlet and/or outlet opening in different planes.

10. The worksite lamp according to claim 1, wherein:
the lighting unit comprises at least one heat sink which bounds a channel of the fluid-conducting unit, and
the channel is fluidically connected to a further channel of the fluid-conducting unit which is arranged on the housing and opens in a near region of the battery receptacle interface.

11. The worksite lamp according to claim 1, wherein:
the worksite lamp is a 360° worksite lamp, and
the at least one lighting unit is configured to emit light over an angular range of more than 180°.

12. The worksite lamp according to claim 1, wherein the fluid is water and/or cooling air.

13. The worksite lamp according to claim 1, wherein the fluid-conducting unit comprises at least one fluid inlet and/or fluid outlet element which is arranged in a near region of the battery receptacle interface, with a smallest distance of less than 100 mm.

14. The worksite lamp according to claim 1, wherein the fluid-conducting unit comprises at least one fluid inlet and/or fluid outlet element which is arranged in a near region of the battery receptacle interface, with a smallest distance of preferably less than 20 mm.

15. The worksite lamp according to claim 4, wherein the at least one fluid inlet and/or fluid outlet element is at least one upper fluid inlet and/or fluid outlet element.

16. The worksite lamp according to claim 2, wherein:
the battery receptacle interface, viewed along a battery insertion direction of the battery receptacle interface, has a minimum distance relative to an outer housing surface of the housing that is greater than 30 mm, and
the at least one fluid inlet and/or fluid outlet element is arranged behind the battery receptacle interface along the insertion direction.

17. The worksite lamp according to claim 1, wherein:
the lighting unit comprises at least one heat sink which bounds a substantially fully closed channel of the fluid-conducting unit, and
the substantially fully closed channel is fluidically connected to a further channel of the fluid-conducting unit which is arranged on the housing and opens in a near region of the battery receptacle interface.
